(19) United States
(12) Patent Application Publication
(10) Pub. No.: US 2011/0214532 A1
(43) Pub. Date: Sep. 8, 2011

(54) DOUBLE CLUTCH WITH A DIFFERENTIATOR

(75) Inventor: Eckhard KIRCHNER, Ginsheim (DE)

(73) Assignee: GM GLOBAL TECHNOLOGY OPERATIONS LLC, Detroit, MI (US)

(21) Appl. No.: 13/041,584

(22) Filed: Mar. 7, 2011

(30) Foreign Application Priority Data
Mar. 5, 2010 (GB) 1003679.6

(51) Int. Cl. F16H 3/08; F16D 21/00; F16D 25/10

(52) U.S. Cl. 74/665 A; 192/48.1; 192/48.601

(57) ABSTRACT

A double clutch includes, but is not limited to an inner clutch for connecting to an inner input shaft to a crankshaft of an engine. The double clutch also includes, but is not limited to an outer clutch for connecting to an outer input shaft to the crankshaft. The double clutch further includes, but is not limited to one or more differentiators coupled to at least one levers of the two clutches for providing adjustments in stroke distance to at least one of the two clutches for clutching.

### CROSS-REFERENCE TO RELATED APPLICATION

This application claims priority to British Patent Application No. 1003679.6, filed Mar. 5, 2010, which is incorporated herein by reference in its entirety.

### TECHNICAL FIELD

The technical field relates to a double clutch with a differentiator. The present application also relates to a method of using the double clutch with the differentiator.

### BACKGROUND

Double clutches have been increasingly more accepted by manufacturers for producing cars. The double clutches are subjected to thermal influence and wear during usage, which compromise performance of the double clutches. The thermal influence and wear can lead to severe deterioration in efficiency and reliability if a double clutch uses one actuator to actuate two clutches of the double clutch.

### SUMMARY

A double clutch is provided that comprises an inner clutch and an outer clutch. The inner clutch provides engagement and disengagement between an inner input shaft and a crankshaft of an engine. The engine can be an internal combustion engine, an electric motor, or a hybrid engine for generating driving torque. The crankshaft is an output shaft that exerts the driving torque. Here, the output shaft of the engine is termed as a crankshaft for convenience, which can also include a straight shaft of an electric motor. The outer clutch is arranged for connecting or disconnecting an outer input shaft to the crankshaft. The outer input shaft encloses a part of the inner input shaft such that these two input shafts are coaxial. Only one of the two input shafts is connected to the crankshaft at a time for receiving the driving torque.

One or more differentiators are coupled to one or more clutch levers of the two clutches for providing adjustment in stroke distances of the two respective clutches automatically for clutching. The two clutches can share the differentiator for compensating wear of the clutches respectively. Alternatively, each of the two clutches can have a differentiator of its own. The differentiator can be attached to an actuator of the double clutch for pushing a clutch lever via a clutch bearing. The clutch lever is also known as a plate spring or a clutch diaphragm.

The differentiator is also known as a micro-scale actuator that generates relatively a small change in stroke distance as compared to any of the complete stroke distances of the two clutches respectively. The stroke distance indicates an entire range that an actuator operates for activating or deactivating a clutch. The small change is known as stroke differentiation, in contrast to stroke provision of the two clutches. The small change can be one order of magnitude smaller than the stroke distance of any of the two clutches. The small change in stroke distance enables adjustments in stroke distance, which fine-tunes the performance of the double clutch. The adjustment can be used to compensate wear, thermal influence of the double clutch so that the double clutch can facilitate efficient, powerful and comfortable gearshifts. Since friction plates of the double clutch can be worn by the usage, initially set stroke distances may no longer provide accurate and sufficient gripping for the double clutch. The differentiator can be attached to any of the two clutches to slightly increase or decrease the stroke distance such that the initial setting of friction grip can be maintained or even improved.

The adjustment of the differentiator can either be done manually or automatically. When done manually, a user is enabled to set his personal preference to suit his driving preference, such as for speedy moving-off. When done automatically, a sensor can be installed in the double clutch so that the double clutch can be maintained at a desired friction sufficiency for engaging the input shafts. A driver is relieved from having to check on performance of the double clutch over a long distance of driving. Moreover, an automatically controlled differentiator can send a warning signal to a driver if wear and tear of the double clutch is beyond the compensation capacity of the differentiator. The same sensor can monitor the friction grip force of the double clutch, which may deteriorate due to excessive heat, moisture, or component corrosion.

The differentiator can comprise an inner differentiator and an outer differentiator. The inner differentiator is connected to the inner clutch for providing adjustment in stroke distance of the inner clutch automatically. An outer differentiator is coupled to the outer clutch for providing adjustment in stroke distance of the outer clutch automatically. The two differentiators can compensate the two clutches separately to suit their individual requirements. For example, the inner differentiator may provide larger increment for reducing stroke distance of the inner clutch because the inner clutch is worn badly due to its frequent usage.

The double clutch can further comprise a differentiation actuator, which is coupled to both the inner clutch and the outer clutch. The differentiation actuator is operable between a deactivated position and an activated position to engage the crankshaft to any of the two input shafts or to disengage the crankshaft from any of the two input shafts. The engagement of the one input shaft and the disengagement of the other input shaft are performed simultaneously. In construction, one of the two clutches engages an input shaft and the other disengages from an input shaft in a default position. The default position can be provided when the differentiation actuator is deactivated. When triggered, the originally engaged clutch disengages from the input shaft, whilst the other previously disengaged clutch engages its corresponding input shaft in an activated position. In either the default or the activated position, one of the two clutches engages one of the two input shafts to the crankshaft. For example, in a default position, the outer clutch engages the outer input shaft to the crankshaft, and the inner clutch disengages the inner input shaft from the crankshaft. When the differentiation actuator carries out a full stroke for activating the double clutch, the outer clutch disengages the outer input shaft from the crankshaft, whilst the inner clutch engages the inner input shaft to the crankshaft. In performing the stroke, the differentiation actuator moves from a deactivated position to an activated position for engaging one of the two clutches to one of the two input shafts such that engagement of the one of the two clutches and disengagement of the other are performed in parallel. The deactivated position is often adopted as the default position. The double clutch uses one differentiation actuator instead of two. The reduction of component helps make the double clutch to be more compact, of less weight and at lower cost.

The inner clutch can be disengaged from the crankshaft and the outer clutch can be engaged to the crankshaft in the deactivated position, which is a default state of the double clutch. The double clutch can work in the absence of power supply. For example, the outer clutch can be biased to engage the outer input shaft to the crankshaft by spring force of an outer clutch lever and the inner clutch can be in the mean time biased to disengage the inner input shaft from the crankshaft. Hydraulic or pneumatic pressure reservoir can provide similar biasing force for providing the default position. The deactivated position indicates a state that the differentiator functions in the absence of the external power supply. Alternatively, the inner clutch can be engaged to the crankshaft and the outer clutch can be disengaged from the crankshaft in the activated position.

The double clutch can comprises a dry double clutch such that the inner differentiator is contiguous to an inner clutch bearing of the dry double clutch, and the outer differentiator is attached to an outer clutch bearing of the dry double clutch. The clutch bearings situate between the differentiators and the clutch levers respectively such that the clutch levers can rotate with respect to the differentiators.

The double clutch can also comprise a wet double clutch that includes a wet inner clutch and a wet outer clutch. The wet inner clutch and the wet outer clutch are radially disposed around a longitudinal axis of the wet double clutch. For example, inner pressure plates and inner friction plates of the wet double clutch can be disposed around outer pressure plates and outer friction plates. The radial arrangement of the wet inner clutch and the wet outer clutch helps to reduce size of the wet double clutch in its longitudinal axial direction.

The differentiation actuator can provide linear differentiation to any of the two differentiators. The linear differentiation enables a uniform adjustment to a stroke distance of the inner differentiator. The uniform adjustment can either be an increase or a decrease to a stroke distance throughout its complete stroke distance. The linear differentiation is also applicable to the outer differentiator. The two differentiators may have different sizes of the adjustments to suit varying degrees of wear at the two clutches. The linear differentiation is simple to implement and convenient to calibrate. In general, sizes of the adjustments can proportional to the duration of usage, which is straightforward for car workshop to carry out during car maintenance.

The differentiation actuator can further provide non-linear differentiation to any of the two differentiators. The non-linear differentiation provides non-uniform adjustment to stroke distance of the inner differentiator or the outer differentiator. For example, in a normally closed outer clutch, the outer clutch can be accelerated in opening before reaching a midpoint of its stroke distance. The accelerated opening may be in the form of increased gap between a friction plate and a pressure plate of the outer clutch. The outer clutch can then be decelerated in opening after passing through the midpoint of the stroke distance. The non-linear differentiation provides smooth and efficient transitions between opening and closing of a clutch.

The double clutch that comprises a single main actuator has one normally open and one normally closed clutch. The double clutch can provide a linear type of differentiator movement if uneven wear of the two clutch discs needs to be compensated. The double clutch can also provide a non-linear type of differentiator movement for compensating differences of diaphragm spring characteristics of the two different clutches. Generally, reasonable controllability of the clutch-to-clutch shift event for meeting an expectation of high drive quality requires an almost full flexibility of position control in both clutches for systems having two naturally open clutches. The present double clutch, which has one normally open and the other normally closed clutch, can sufficiently meet the requirement on controllability by the differentiator movements.

Any of the two differentiators can comprise a piezoelectric direct working system. The piezoelectric direct working system utilises materials with piezoelectric properties to achieve an adjustment of stroke distance. Since the piezoelectric material can be operated electrically, a micro change of the inner clutch can be easily adjusted and accurately regulated by electronic circuits, such as a computer. Operations of the inner differentiator or the outer differentiator can be automated. The outer differentiator can also comprise a piezoelectric direct working system, similar to that of the inner differentiator.

The inner differentiator or the outer differentiator can comprise a hydraulic direct working system, a pneumatic direct working system, or in combination of both. The hydraulic direct working system adopts one or more hydraulic cylinders to give a linear force through a stroke. The hydraulic cylinder is also called a linear hydraulic motor. The hydraulic cylinder comprises a cylinder barrel, in which a piston connected to a piston rod moves back and forth. The barrel is closed on each end by a cylinder bottom and by a cylinder head where the piston rod comes out of the cylinder. The piston has sliding rings and seals. The piston divides an interior of the cylinder in two chambers, the bottom chamber and the piston rod side chamber. The hydraulic pressure acts on the piston to carry out linear work and motion. The hydraulic cylinder can also be a telescopic cylinder, a plunger cylinder, a differential cylinder, or a rephasing cylinder. Oil based hydraulic direct working system can provide precise adjustment of the micro change in stroke distance. Furthermore, the outer differentiator can also comprise the hydraulic direct working system.

Any of the two differentiators can comprise a mechanically actuated indirect system. The mechanically actuated indirect system employs machinery components other than hydraulic and pneumatic parts. For example, the mechanically actuated indirect system employs an electric motor driven inner differentiator through a series coupled gears, shafts, pulleys, belts, or others. The outer differentiator can also comprise a mechanically actuated indirect system. Mechanically actuated indirect system is cheap to build and easy to maintain.

The double clutch can further comprise a restoring mechanism for restoring the double clutch from the activated position to the default position in the absence of external power supply. Since the double clutch has two positions, the default position and the activated position, the double clutch avoids having two actuators to actuate the two clutches for having the two positions. Instead, there can be only one differentiation actuator for providing the two positions, and this scheme brings substantial amount of size and cost saving to the double clutch.

A double clutch transmission is provided with an inner input shaft and an outer input shaft. The outer input shaft surrounds a portion of the inner input shaft. A layshaft is spaced apart from the input shafts and arranged in parallel to the input shafts. A pinion of the double clutch transmission is mounted on the layshaft. In the double clutch transmission, gearwheels of a launch gear are mounted on one of the input shafts and the layshaft. The launch gear is a gear speed that a vehicle with the double clutch transmission normally moves off. The gearwheels comprise a driving gearwheel on the one of the input shafts meshing with a driven gearwheel on the layshaft. The driving gearwheel is a gearwheel on one of the input shafts for receiving driving torque from the crankshaft. In contrast, the driven gearwheel meshes directly or indirectly with the driving gearwheel for receiving the driving torque from the driving gearwheel.

The gearwheels of the launch gear have a coupling device on the layshaft for engaging the driven gearwheel to the layshaft or disengaging the driven wheel from the layshaft. In the default state or position, the coupling device is disengaged from the driven gearwheel.

The double clutch transmission can use only one differentiation actuator for choosing to transmit the driving torque from the crankshaft to any of the two input shaft. The differentiation actuator can have a piston for having an extending motion and a retracting motion. The differentiation actuator extends its piston and pushes a clutch lever to a full stroke distance to arrive an activated state of the double clutch. In contrast, the piston is withdrawn as in a deactivated state, such that the clutch lever springs back by its resilience and the double clutch resumes its default state. The double clutch transmission can be made at a reduced cost by removing one actuator.

The double clutch transmission can further comprise gearwheels of a driving gear. The gearwheels comprise a second driven gearwheel that is connected to the double clutch in the default position. The driving gear includes a second gear, a third gear, or other higher gears for providing higher output speeds of the double clutch transmission. The driving gear provides suitable cruise speed of a vehicle for travelling. The double clutch transmission thus becomes suitable for a wide range of applications.

A vehicle is provided that has the double clutch transmission. The double clutch transmission is connected between the crankshaft of an engine and a differential. The double clutch transmission can also comprise a park-lock gearwheel. The park-lock gearwheel is a fixed gearwheel on the layshaft for providing secure parking of the vehicle. The safety feature is useful for protecting the vehicle, its passengers and its surroundings.

A method is provided for using a double clutch. The method comprises the steps of providing the double clutch that has an inner clutch and an outer clutch. The method also has a step of activating the double clutch by engaging the inner clutch to an input shaft and disengaging the outer clutch from the other input shaft simultaneously. The double clutch can have two positions only, namely the default position and the activated position. Since the double clutch takes very little time for switching between the two positions, torque transmission from the crankshaft to the double clutch transmission is almost not interrupted. Therefore, negligible loss of torque transmission occurs during the switching, which is fuel efficient and comfortable for driving.

The method can further comprise a step of deactivating the double clutch by disengaging the inner clutch from the input shaft and engaging the outer clutch to the outer input shaft simultaneously. When deactivated, the double clutch resumes the default position where the inner clutch disengages the crankshaft from the inner input shaft and the outer clutch engages the crankshaft to the outer input shaft. In the activated position, the inner clutch engages the crankshaft to the inner input shaft and the outer clutch disengages the crankshaft from outer input shaft. The default position and the activated position may be interchanged depending on construction of the double clutch. The double clutch with the two positions is simple to built and reliable in performance.

The method can further comprise a step of adjusting a stroke distance of any of the two clutches. The adjustment of stroke distance is relatively small, as compared to a full stroke distance. The adjustment is also known as a micro change of the stroke distance for compensating thermal influence and wear of the double clutch during usage. The compensation ensures reliable and improved performance of the double clutch. The adjustment can either be done manually in a car workshop or automatically by an onboard computer of a vehicle having the double clutch.

In the application, the actuator, one ore more of the differentiators, or all of them can be operated in a closed loop control environment or in an open loop control environment. To support controllability of the double clutch with only one main actuator and one differentiator, it is beneficial to operate the system in a closed loop control environment. The closed loop control environment enables the double clutch to operate more stable and reliable. The double clutch that is operated in the closed loop environment can be based on mathematical models, which require respective calibrations. One technique of providing the closed-loop control is monitoring rotation speed of an input shaft during a shift to avoid driveline vibration influence on drive quality. In such a case, input speed sensor signals can be frequency filtered to detect higher order vibrations, which can in turn be wiped out through hydraulic dithering of the ongoing clutch system.

The main actuator and the differentiator can alternatively be operated in an open loop control system. The open loop control system is easy to implement and debug. The open loop control system uses look-up tables that limit a range of applicability of algorithms to a parameter range covered by the look-up tables.

### BRIEF DESCRIPTION OF THE DRAWINGS

The present invention will hereinafter be described in conjunction with the following drawing figures, wherein like numerals denote like elements, and

FIG. 1 illustrates a schematic diagram of a double clutch;

FIG. 2 illustrates structures of a dry double clutch according to the schematic diagram of FIG. 1;

FIG. 3 illustrates a cross sectional view of the dry double clutch that is in a default position;

FIG. 4 illustrates a cross sectional view of the dry double clutch that is in an activated position;

FIG. 5 illustrates a double clutch transmission that comprises the dry double clutch of FIG. 2;

FIG. 6 illustrates a coupling device of the double clutch transmission;

FIG. 7 illustrates working principles of the differentiation actuator based on a piezoelectric direct working system;

FIG. 8 illustrate a torque-stroke diagram of a dry outer clutch with micro change of closure;

FIG. 9 illustrate a torque-stroke diagram of a dry inner clutch with the micro change of opening;

FIG. 10 illustrates a wet double clutch according to the schematic diagram;

FIG. 11 illustrates various operating status of the dry double clutch with differentiation actuators;

FIG. 12 illustrates a torque-stroke diagram of the dry outer clutch with another micro change of closure;

FIG. 13 illustrate a torque-stroke diagram of a dry inner clutch with another micro change of opening;

FIG. 14 illustrates working principles of the differentiation actuator based on a hydraulic direct working system; and

FIG. 15 illustrates working principles of the differentiation actuator based on a mechanically actuated indirect system.

### DETAILED DESCRIPTION

The following detailed description is merely exemplary in nature and is not intended to limit application and uses. Furthermore, there is no intention to be bound by any theory presented in the preceding background or summary or the following detailed description.

In the following description, details are provided to describe one or more embodiments of the application. It shall be apparent to one skilled in the art, however, that these embodiments may be practised without such details.

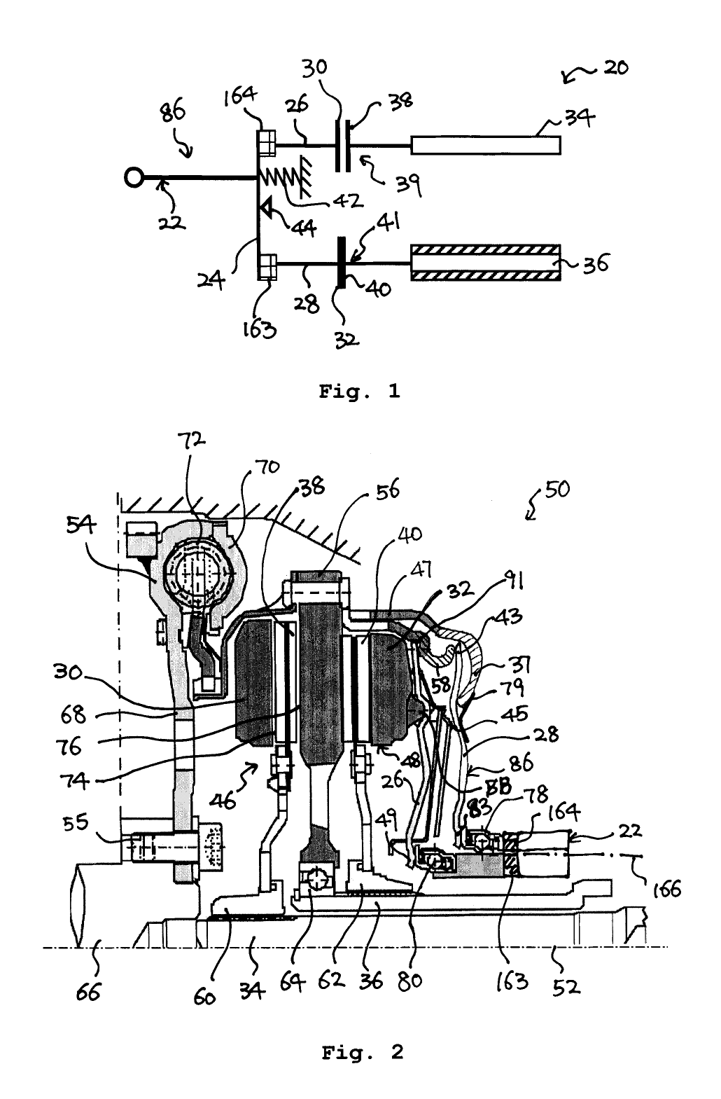

FIGS. 1-9 facilitate detailed description of a first embodiment of a double clutch 20 of the present application. FIGS. 1-9 comprise parts that have same reference numbers. Relevant description of these parts is incorporated where appropriate.

FIG. 1 illustrates a schematic diagram of a double clutch 20. The double clutch 20 comprises an actuator 22 that is connected to an inner clutch 39 and to an outer clutch 41. The inner clutch 39 is further connected to an inner input shaft 34 whilst the outer clutch 41 is further connected to an outer input shaft 36. The inner input shaft 34 is also known as an inner shaft. Similarly, the outer input shaft 36 is also known as an outer shaft. In practice, the outer input shaft 36 encloses the inner input shaft 34 coaxially, although the inner input shaft 34 and the outer input shaft 36 are drawn separately in FIG. 1.

The double clutch 20 comprises an actuator 22 that also connects a differentiator carrier 24 extending from the actuator 22 perpendicularly. The differentiator carrier 24 has an outer differentiator 163 and an inner differentiator 164 at its opposite ends, which further connect to two clutch levers 26, 28 respectively. These two differentiators 163, 164 are better illustrated with some following Figures. A pivot 44 and a biasing spring 42 of the differentiation actuator 22 are located on an opposite side of the differentiator carrier 24. The differentiator carrier 24 is supported by the biasing spring 42 and the differentiator carrier 24 can tilt around the pivot 44.

The inner clutch 39 comprises an inner friction plate 38 and an inner pressure plate 30. The inner friction plate 38 is arranged parallel to the inner pressure plate 30. The inner friction plate 39 is connected to the inner input shaft 34 and the inner pressure plate 30 is connected to an inner clutch lever 28. The inner clutch lever 28 is further connected to an end of the differentiator carrier 24.

Similarly, the outer clutch 41 comprises an outer friction plate 40 and an outer pressure plate 32. The outer pressure plate 32 is arranged parallel to the outer friction plate 40. The outer friction plate 40 is connected to the outer input shaft 36 and the outer pressure plate 32 is connected to the outer clutch lever 26. The outer clutch lever 26 is further connected to another end of the cross bar. The two clutch levers 26, 28 are also known as diaphragms or plate springs.

The double clutch 20 has a default position and an activated position. The double clutch 20 can transit between these two positions. Only one of the two clutches 39, 41 of the double clutch 20 is always engaged, while the other clutch 39, 41 is disengaged. The engagement allows transmission of engine torque.

In the default position, which is shown in FIG. 1, no external activation force is applied to the differentiator carrier 24. The biasing spring 42 and the pivot 44 cooperate to disengage the inner clutch 39 and to engage the outer clutch 41. When the inner clutch 39 is disengaged, the inner pressure plate 30 is detached from the inner friction plate 38 and no friction contact is established between the inner friction plate 38 and the inner pressure plate 30. When the outer clutch 41 is engaged, the outer pressure plate 32 is attached to the outer friction plate 40 and friction contact is established between the outer pressure plate 32 and the outer friction plate 40.

In the activated position, which is shown in FIG. 4, the differentiator carrier 24 receives the external activation force. The external activation force pushes the differentiator carrier 24 forward such that the biasing spring 42 and the pivot 44 cooperate to engage the inner clutch 39 and to disengage the outer clutch 41. When the inner clutch 39 is engaged, the inner pressure plate 30 is attached to the inner friction plate 38 and friction contact is established between the inner pressure plate 30 and the inner friction plate 38. When the outer clutch 41 is disengaged, the outer pressure plate 32 is detached from the outer friction plate 40 and no friction contact is established between the outer pressure plate 32 and the outer friction plate 40.

FIG. 2 illustrates structures of an upper half of a dry double clutch 50 according to the schematic diagram of FIG. 1. The dry double clutch 50 includes components of the double clutch 20 of FIG. 1. The dry double clutch 50 is symmetrical about its longitudinal axis 52.

FIG. 2 shows the dry double clutch 50 that is connected between a flywheel 54 and two coaxial input shafts 34, 36. The dry double clutch 50 comprises a dry inner clutch 46, a dry outer clutch 48, an actuator 22, a centre plate 56 and some other components. The flywheel 54 is a dual mass flywheel that comprises a primary flywheel 70 and a secondary flywheel 68. The secondary flywheel 68 is mounted on a crankshaft 66 of an engine for outputting driving torque of the engine to the dry double clutch 50. The flywheel 54 is fixed to the crankshaft 66 via bolts 55. The two input shafts 34, 36 are inserted into a cavity of the dry double clutch 50 such that one of the two input shafts 34, 36 can receive the driving torque from the crankshaft 66 via the dry double clutch 50.

There are two clutch bearings 78, 80 attached to the differentiation actuator 22 via two differentiators 163, 164 respectively. In particular, an inner clutch bearing 78 is attached to an inner differentiator 164, whilst an outer clutch bearing 80 is attached to an outer differentiator 163. The two clutch levers 26, 28 are attached to the clutch bearings 78, 80 respectively such that they can freely rotate around the two input shafts 34, 36. The differentiation actuator 22 is held stationary in radial direction of the longitudinal axis 52, but it can move in parallel with the longitudinal axis 52.

The dry inner clutch 46 comprises an inner friction plate 38 for attaching frictionally between an inner pressure plate 30 and a centre plate 56. The inner pressure plate 30 is connected to the differentiation actuator 22 via a clutch apply cylinder 47, an inner clutch clip 79 and an inner clutch lever 28. The inner friction plate 38 is supported by an inner splined hub 60 that is further placed on the protruding end of the inner input shaft 34. The inner pressure plate 30 is positioned next to a first side of the centre plate 56. The inner input shaft 34 and the inner splined hub 60 are arranged such that the inner splined hub 60 is mounted onto the inner input shaft 34 and the inner splined hub 60 meshes with the inner input shaft 34. The inner splined hub 60 has an array of grooves that meshes with a series of spaced ridges on the inner input shaft 34 such that the inner splined hub 60 can have axial movement on the inner input shaft 34.

The dry outer clutch 48 comprises an outer friction plate 40 for attaching frictionally between an outer pressure plate 32 and the centre plate 56. The outer pressure plate 32 is connected to the actuator 22 via the outer clutch lever 26. The outer friction plate 40 is supported by an outer splined hub 62 that is placed on the outer input shaft 36. The outer friction plate 40 is positioned next to a second side of the centre plate 56. The second side is opposite to the first side. The outer input shaft 36 and the outer splined hub 62 are arranged such that the outer splined hub 62 is mounted onto the outer input shaft 36 and the outer splined hub 62 meshes with the outer input shaft 36. The outer splined hub 62 has an array of grooves that meshes with a series of spaced ridges on the outer input shaft 36 such that the outer splined hub 62 can move axially on the outer input shaft 36.

The differentiation actuator 22 comprises an inner arm and an outer arm to activate any of the two clutches 46, 48 at a time. By default, the dry outer clutch 48 is activated and the dry inner clutch 46 is deactivated. When the differentiation actuator 22 moves to another position, the dry outer clutch 48 is deactivated and the dry inner clutch 46 becomes activated.

The actuator 22 is connected to both of the two clutches 46, 48. A circumferential edge of the centre plate 56 is joined to the flywheel 54 whilst a centre portion of the centre plate 56 is supported by a ball bearing 64 that is placed on the outer input shaft 36. These parts are adapted such that the centre plate 56 is rotatable about the outer input shaft 36. The dry inner clutch 46 is located on the left of the centre plate 56 and the dry outer clutch is located on the right of the centre plate 46.

An inner arm of the dry double clutch 50 includes the inner differentiator 164, the inner clutch bearing 78, the inner clutch lever 28, the inner clutch clip 79, the clutch apply cylinder 47 that are sequentially joined together. The inner differentiator 164 is connected to the inner clutch bearing 78, which is also connected to the inner clutch lever 28 at its inner clutch lever central end 83, which is a bottom end. An upper end 43 of the inner clutch lever 28 is held between an annular bead 37 of the clutch apply cylinder 47 and the clutch cover 58. The upper end 43 is also known as a remote end. The inner clutch clip 79 is attached between a middle portion of the inner clutch lever 28 and an end of the clutch apply cylinder 47 for joining them together. In an alternative, the inner clutch clip 79 can be replaced by a rivet that connects the end of the clutch apply cylinder 47 and the inner clutch lever 28 together.

On one hand, by default, natural spring force of the inner clutch clip 79 causes the inner clutch lever 28 to tilt for biasing the clutch apply cylinder 47. The inner clutch lever 28 is further connected to the inner pressure plate 30 and the natural spring force detaches the inner pressure plate 30 away from the inner friction plate 38 for opening the dry inner clutch 46. On the other hand, as the actuator 22 moves to the activated position, the inner clutch lever 28 rotates around its middle portion and the remote end 85 causes the elongated lever arm 57 to shift. The advancement of the clutch apply cylinder 47 brings the inner pressure plate 30 onto the inner friction plate 38, thus engages the dry inner clutch 48.

The inner clutch bearing 78 maintains contacts with both the inner clutch lever 28 and with the inner differentiator 164 when the inner clutch lever 28 rotates around the longitudinal axis 52.

The outer arm comprises the outer differentiator 163, an outer clutch bearing 80 and an outer clutch lever 26. The outer differentiator 163 is connected to the outer clutch bearing 80, which is also connected to the outer clutch lever 26 at its outer clutch lever central end 49. The outer clutch lever central end 49 is also known as a bottom end 49 A remote end 91 of the outer clutch lever 26 is held with the clutch cover 58 as a pivotal joint. A middle portion of the outer clutch lever 26 is joined to the outer pressure plate 32 via a ball joint 88. The outer clutch lever 26 can tilt around the remote end 91 for bring the outer pressure plate 32 onto or away from outer friction plate 40. Natural spring force of the outer clutch lever 26 biases the outer pressure plate 32 onto the outer friction plate 40 for engaging the dry outer clutch 48. The outer clutch bearing 80 maintains contacts with both the outer clutch lever 26 and with the outer branch 84 when the outer clutch lever 26 rotates around the longitudinal axis 52.

The crankshaft 66 translates reciprocating linear motion of pistons of an engine into rotational motion of the crankshaft 66. The rotational motion transmits a driving torque from the pistons to the flywheel 54. The flywheel 54 has a significant moment of inertia for storing rotational energy that is converted from the driving torque. The moment of inertia also absorbs fluctuations of the driving torque. The centre plate 56 receives the driving torque from the flywheel 54 via their connection.

The dry double clutch 50 acts to transmit the driving torque from the crankshaft 66 to either the inner input shaft 34 or the outer input shaft 36. The dry double clutch 50 interchanges between a default position and an activated position. The dry double clutch 50 transmits the driving torque from the flywheel 54 to one of the input shafts 34, 36 at any of these two positions. In the default position, the dry inner clutch 46 is engaged and the dry outer clutch 48 is disengaged. In the activated position, the dry inner clutch 46 is disengaged and the dry outer clutch 48 is engaged.

When the dry inner clutch 46 is disengaged, which is shown in FIG. 2, a left inner gap 74 of roughly 0.75 mm exists between the inner pressure plate 30 and the inner friction plate 38. In the mean time, a right inner gap 76 of the same magnitude exists between the centre plate 56 and the inner friction plate 38. The gaps 76, 78 exist such that there is no friction contact between the inner friction plate 38 and the centre plate 56. When the dry inner clutch 46 is engaged, the inner pressure plate 30, the inner friction plat 38 and the centre plate 56 are clamped together with no gap in-between all of them.

Similarly, when the dry outer clutch 48 is disengaged, a left outer gap of approximately 0.75 mm exists between the outer pressure plate 32 and the outer friction plate 40. In the mean time, a right outer gap of the same magnitude exists between the centre plate 56 and the outer friction plate 40. The gaps exist such that there is no friction contact between the outer friction plate 40 and the centre plate 56. When the dry outer clutch 46 is engaged, the outer pressure plate 32, the outer friction plat 40 and the centre plate 56 are clamped together with no gap in-between all of them.

In particular, the dry inner clutch 46 acts to receive the driving torque from the flywheel 56 when it is engaged. In the engaged state, the inner pressure plate 30 forces the inner friction plate 38 onto the centre plate 56 for providing friction contact between the inner friction plate 38 and the centre plate 56. The inner friction plate 38 is used for receiving the driving torque from the centre plate 56 when the friction contact is established. The inner friction plate 38 is also intended for transmitting the driving torque to the inner input shaft 34 via the meshing between the inner splined hub 60 and the inner input shaft 34. The inner input shaft 34 is used for delivering the driving torque to wheels of a vehicle. The driving torque of the inner input shaft 34 is delivered to fixed gearwheels that are mounted on the inner input shaft 34 and further to idler gearwheels that comb with the fixed gearwheels.

The differentiation actuator 22 acts for providing an external activation force to engage the dry inner clutch 46. The inner clutch bearing 78 is used for conveying the external activation force to the inner clutch lever 28. The inner clutch lever 28 is provided for receiving the external activation force from the inner clutch bearing 78 and for applying the force onto the inner pressure plate 30. The pivot 44 is intended for tilting the inner clutch lever 28 when the inner clutch lever 28 is moved by the inner clutch bearing 78. The inner pressure plate 30 is used for moving the inner friction plate 38 onto the centre plate 56 for providing the friction contact.

Similarly, the dry outer clutch 48 acts to receive the driving torque from the flywheel 56 when it is engaged. In the engaged state, the outer pressure plate 32 forces the outer friction plate 40 onto the centre plate 56 for providing friction contact between the outer friction plate 40 and the centre plate 56. The outer friction plate 40 is used for receiving the driving torque from the centre plate 56 when the friction contact is established. The outer friction plate 40 is also intended for transmitting the driving torque to the outer input shaft 36 via the meshing between the outer splined hub 62 and the outer input shaft 36. The outer input shaft 36 is used for delivering the driving torque to the wheels of the vehicle. The driving torque of the outer input shaft 36 is delivered to fixed gearwheels that are mounted on the outer input shaft 36 and further to idler gearwheels that comb with the fixed gearwheels.

The actuator also acts for providing an external activation force to engage the dry outer clutch 48. The outer clutch bearing 80 is used for conveying the external activation force to the outer clutch lever 26. The outer clutch lever 26 is provided for receiving the external activation force from the outer clutch bearing 80 and for applying the force onto the outer pressure plate 32. The outer pressure plate 32 is used for moving the outer friction plate 40 onto the centre plate 56 for providing the friction contact.

A method of using the dry double clutch 50 is described below. The engine is firstly started while the vehicle is still in a standstill position. The differentiation actuator 22 does not exert the external activation force. Hence, the dry double clutch 50 is in the default position. The driving torque is then transmitted from the crankshaft 66, via the flywheel 54, via the centre plate 56, via the dry outer clutch 48, to the outer input shaft 36. Later the differentiation actuator 22 exerts the external activation force. The dry double clutch 50 afterward shifts to the activated position. The driving torque is then transmitted from the crankshaft 66, via the flywheel 54, via the centre plate 56, via the dry inner clutch 48, to the inner input shaft 34. By alternating between the activated position and the default position, the driving torque is transmitted to either the outer input shaft 36 or to the inner input shaft 34.

The dry dual clutch 50, which is operated by the single differentiation actuator 22 and its attached differentiators 163, 164 is beneficial to be used in a closed loop controls environment. The closed loop controls operate more stable and reliable. The closed loop controls are based on mathematical models, which require respective calibrations. One aspect of the closed loop controls includes monitoring achieved rotational input shaft speed during a shift to avoid driveline vibrations impacting drive quality. In such a case, an input speed sensor signal is frequency filtered to detect higher order vibrations which can in turn be wiped out through hydraulic dithering of the ongoing clutch system.

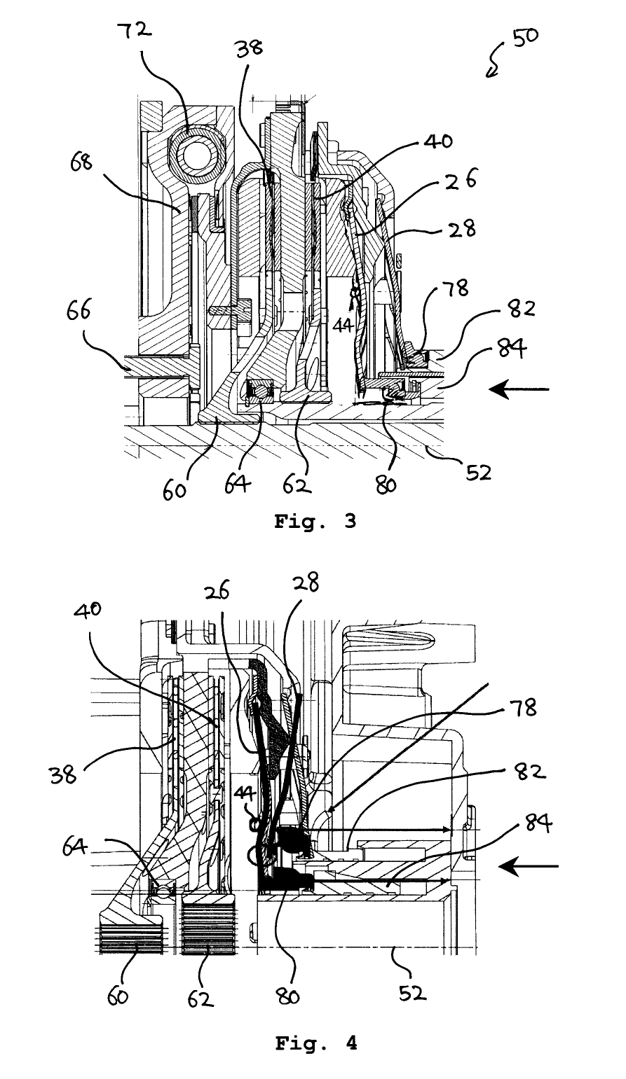

FIG. 3 illustrates a cross sectional view of the dry double clutch 50 that is in the default position. FIG. 4 illustrates a cross sectional view of the dry double clutch 50 that is in an activated position. No interference is found between two clutch levers 26, 28 in any of these two positions.

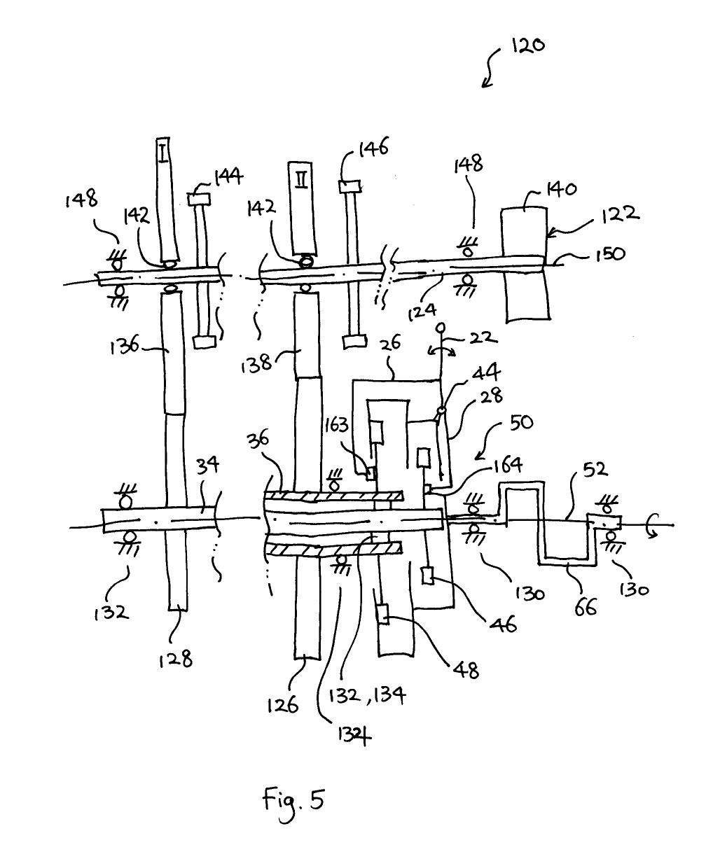

FIG. 5 illustrates a double clutch transmission 120. The double clutch transmission 120 comprises a gearbox 122 and the dry double clutch 50 of FIG. 1-4. The dry double clutch 50 is connected between the crankshaft 66 of FIG. 1-4 and the gearbox 122. The crankshaft 66 is supported on crankshaft bearings 130 at its two opposite ends.

The gearbox 122 comprises the two input shafts 34, 36 of FIG. 1 and a layshaft 124. The layshaft 124 is positioned parallel to the input shafts 34, 36. The layshaft 124 has a longitudinal axis 150 as its axis of rotation.

The inner input shaft 34 is inserted into the outer input shaft 36 in forming an input shaft assembly. Input shaft bearings are installed between the two input shafts 34, 36 for joining them together. The input shaft assembly has a first end and a second end. The inner input shaft 34 protrudes from the outer input shaft 36 at the first end. The second end of the input shaft assembly is inserted into and is connected to the dry double clutch 50. A first fixed gearwheel 128 is fixed onto the protruding portion of the inner input shaft 34. A second fixed gearwheel 126 is fixed onto the outer input shaft 36.

The layshaft 124 is supported on bearings 148. A first idler gearwheel 136, a second idler gearwheel 138, the two coupling devices 144, 146 and a pinion 140 are provided on the layshaft 124. In particular, the first idler gearwheel 136 and the second idler gearwheel 138 are mounted onto the layshaft 124 via bearings 142. A first coupling device 144 is mounted next to the first idler gearwheel 136. A second coupling device 146 is mounted next to the second idler gearwheel 138. The pinion 140 is fixed at an end of the layshaft 124 that neighbours the second coupling device 146.

The first idler gearwheel 136 meshes with the first fixed gearwheel 128 and the second idler gearwheel 138 meshes with the second fixed gearwheel 126.

The first coupling device 144 provides synchronisation and locking functions for engaging the first idler gearwheel 136 to the layshaft 124. The first coupling device 144 is able to bring the first idler gearwheel 136 and the layshaft 124 from different rotation speeds to a same rotation speed by the synchronisation. The first coupling device 144 is also able to lock the first idler gearwheel 136 and the layshaft 124 together for transmitting the driving torque. Similarly, the second coupling device 146 provides synchronisation and locking functions for engaging the second idler gearwheel 138 to the layshaft 124.

The first coupling device 144 and the second coupling device 146 have similar structures and parts. Description of the second coupling device 146 is thus applicable to the first coupling device 144 where applicable.

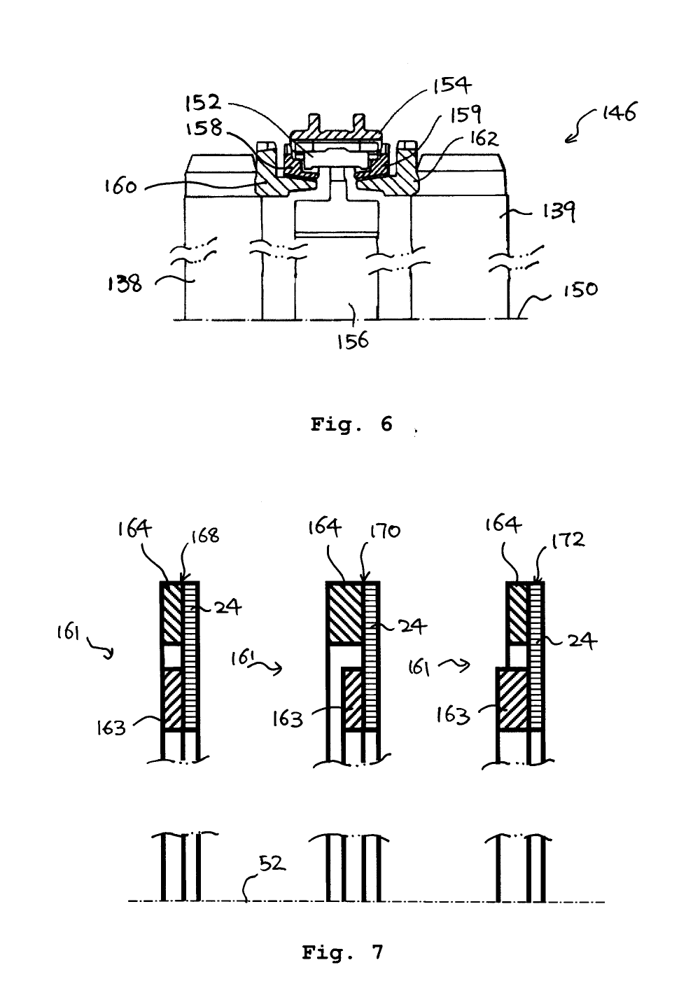

FIG. 6 illustrates the second coupling device 146 of the double clutch transmission 120 in further details. The second coupling device 146 is positioned on the layshaft 124 between the second idler gearwheel 138 and another idler gearwheel 139.

The second coupling device 146 comprises a synchronizer hub 156 and a sleeve 154. The synchronizer hub 156 is fixed to the layshaft 124. The sleeve 154 engages with the synchronizer hub 156 by splines such that the sleeve 154 and the synchronizer hub 156 can rotate together about the layshaft 124 at the same speed. The splines refer to uniformly spaced ridges on the layshaft 124 that fit into corresponding slots on the sleeve 18. The splines are not shown in the FIG. 6. In addition, the sleeve 154 is axially movable on an outer surface of the synchronizer hub 156.

Moreover, the second coupling device 146 includes a first block ring 158, a second block ring 159, and an insert key 152. The insert key 152 abuts the sleeve 154 such that the sleeve 154 can move the insert key 152 in both axial directions of the sleeve 154. The second coupling device 146 also comprises a first dog ring 160 between the second idler gearwheel 138 and the first block ring 158. The first dog ring 160 is fixed to the second idler gearwheel 138 at a side. Similarly, the second coupling device 146 comprises a second dog ring 162 between the other idler gearwheel 139 and the second block ring 159. The second dog ring 162 is fixed to the other idler gearwheel 139 at a side.

In one axial direction, the insert key 152 pushes against the first block ring 158 whilst in the other axial direction, the insert key 152 pushes against the second block ring 159. A first inner peripheral surface of the first block ring 158 is tapered to engage frictionally against a first cone portion of a first dog ring 160. The first cone portion is also called a synchronizer cup. Similarly, a second inner peripheral surface of the second block ring 159 is also tapered to engage frictionally against a second cone portion of a second dog ring 162.

The synchronizer hub 156 and the sleeve 154 are mainly made of steel, but the first and the second block rings 158, 159 are made of brass, which is softer than the steel material for reducing wear loss of the first and the second cone portions.

The dog rings 160, 162 include a number of teeth that are evenly distributed around peripherals of the dong rings 160, 162. The dog rings 160, 162 are moveable along the axis of the layshaft 124 for selectively locking any of the idler gearwheels 138, 139 with the layshaft 124.

In a generic sense, the transmission 120 includes more gearwheels with corresponding coupling devices. The coupling devices can be of double-acting type that is described above for engaging two gearwheels or it can be of a single-acting type, which is designed for engaging only one gearwheel.

Functionally, the first block ring 158 and the first cone portion act as friction members of a first friction clutch for synchronizing the rotational of the second idler gearwheel 138 and the layshaft 124. Likewise, the second block ring 159 and the second cone portion act as friction members of a second friction clutch for synchronizing the idler gearwheel 139 and the layshaft 124.

A method of using the second coupling device 146 comprises a step of moving a shift fork to shift the sleeve 18 in a predetermined axial direction.

In one axial direction, the sleeve 154 that abuts the insert key 152 push the block rings 158 or 159 towards the corresponding gearwheel 138 or 139. The shift lever is not shown in the FIG. 6.

The inner tapered peripheral surface of the block ring 158 or 159 then engages forcedly against the respective cone portions of the gearwheel 138 or 139 as its mating member. This generates a frictional force to synchronize the engaged gearwheel 138 or 139 to the layshaft 124. Further movement of the sleeve 154 in the same direction causes stronger frictional force to bring a rotational speed of the sleeve 154 to be essentially the same rotational speed of the engaged gearwheel 138 or 139.

At this point, the engaged gearwheel 138 or 139 can be inter-locked smoothly with the layshaft 124 with no damage to the gearwheel 138 or 139. The dog rings 160 and 162 rotate at the same speed as the layshaft shaft 124 and the gearwheel 138 or 139. The corresponding dog ring 160 or 162 then slides towards the gearwheel 138 or 139 and it interlocks the selected gearwheels 138 or 139 to the layshaft shaft 124. The dog ring 160 or 162 is prevented from grinding or clashing with the gearwheel 138 or 139 because of the synchronization.

After the interlocking, the sleeve 154 is moved away from the interlocked gearwheel 138 or 139. This also causes the insert key 152 to follow the movement of the sleeve 154, which in turn urges the corresponding block ring 158 or 159 to move in the same direction.

This arrangement prevents the corresponding block ring 158 or 159 from dragging against the cone portion. Wear of the block rings 158 and 159 is reduced.

When in use, the second idler gearwheel 138 and the layshaft 124 normally rotate at varying speeds. To achieve the synchronisation, a gearshift lever pushes the sleeve 154 towards the second idler gearwheel 138. The sleeve 154 in turn moves the insert key 152 and the synchronization hub 156 towards the second idler gearwheel 138. As a result, the first block ring 158 is pushed by the insert key 152 and contacts the first dog ring 160. Friction contact between the first block ring 158 and the first dog ring 160 then cause these two parts to rotate at the same speed. Since the first dog ring 160 is attached to the second idler gearwheel 138, the second idler gearwheel 138 is brought to the same rotation speed as the synchronisation hub 156 because of the friction contact between the block ring 158 and the first dog ring 160. Thus, the second idler gearwheel 138 is synchronized with the layshaft 124.

The second coupling device 146 later further locks the layshaft 124 to the second idler gearwheel 138. The locking happens when the lever (not shown) pushes the sleeve 154 further towards the second idler gearwheel 138. Movement of the sleeve 154 causes the spline of the sleeve 154 engages the first dog ring 160, which locks the second idler gearwheel 138 to the layshaft 124. Consequently, the second coupling device 146 and the second idler gearwheel 138 are connected together and spin at the same speed.

The second coupling device 146 and the second idler gearwheel 138 can be later disengaged when the shift lever moves the sleeve 154 away from the second idler gearwheel 138.

The dry double clutch 50 is deactivated and stays in the default position according to FIG. 5. The dry double clutch 50 is activated when the differentiation actuator 22 moves to the left, which causes the outer clutch lever 26 to rotate around the pivot 44 clockwise as in FIG. 5. The rotation causes the dry outer clutch 48 to disconnect the outer input shaft 36 from the crankshaft 66. In the mean time, the dry inner clutch 46 connects the crankshaft 66 to the inner input shaft 34. The dry double clutch 50 returns to the default position when the differentiation actuator 22 withdraws to the right, which reverse the above-mentioned motions of the activation.

When using the double clutch transmission 120 in a vehicle, the vehicle normally starts when the double clutch transmission 120 is at a Neutral state, which is often actuated by a gear lever in the vehicle. In the Neutral state, the dry outer clutch 48 is in a closed position by default, which causes driving torque from the crankshaft 66 of the engine to be transmitted via the outer input shaft 36, and via the second fixed gearwheel 126, to the second idler gearwheel 138. The second coupling device 146 is not connected the second idler gearwheel 138 to the layshaft 124. The second idler gearwheel 138 is turning whilst the pinion 140 remains stationary.

The vehicle can drive off with the first gear by shifting the gear lever to a Drive position. In the Drive position, the first coupling device 144 is moved to the left to engage the first idler gearwheel 136 to the layshaft 124. This is possible because the dry inner clutch 46 is disengaged from the inner input shaft 34 in the default position, which allows the first idler gearwheel 136 to be stationary for the engagement. By connecting the first coupling device 144 and the first idler gearwheel, the first gear is preselected in the Drive position. The second coupling device 146 is also stationary at this moment because the layshaft 124 has not been driven by the first idler gearwheel 136 yet. Upon releasing the vehicle brake, the dry double clutch 50 is activated such that the dry inner clutch 46 connects the crankshaft 66 to the inner input shaft 34. This causes the first fixed gearwheel 128 to start turning and it transmits the driving torque to the first idler gearwheel 136, to the first coupling device 144, to the layshaft 124, to the pinion 140 and further to the output gearwheel. At the same time, the dry outer clutch 48 has disconnected the outer input shaft 36 from the crankshaft 66. The vehicle drives off with its first gear.

Typically, the gearbox 122 can further be automatically shifted to a second gear with five seconds of driving at the first gear. However, since the second coupling device 146 follows the rotation of the layshaft 124 at the first gear and the second idler gearwheel 138 is freewheeling, the second coupling device 146 and the second idler gearwheel 138 are normally at different speeds. In order to transfer to the second gear, the second coupling device 146 has to synchronise and lock the second idler gearwheel 138 to the layshaft 124. For synchronizing the second idler gearwheel 138 with the second coupling device 146, referring also to FIG. 6, the sleeve 154 shifts to the left which forces the dog ring 160 to ride onto the second idler gearwheel 146 via the block ring 158. As the dog ring 160 experiences increasing pushing force from the sleeve 154, the second coupling device 146 synchronises with the second coupling device 138 via the friction contact between the first dog ring 160 and the first block ring 158. As the sleeve 154 move further towards the second coupling device 138, the spline of the sleeve 154 engages the dog ring 160 such that the second coupling device 146 and the second idler gearwheel 138 are interlocked to each other. The interlocking of the second coupling device 146 and the second idler gearwheel 138 provides reselection of the second gear.

To drive the vehicle at the second gear, the dry double clutch 50 is then deactivated such that the dry inner clutch 46 disconnects the inner input shaft 34, and the dry outer clutch 48 joins back to the outer input shaft 36 at the same time. The driving torque is then transmitted from the crankshaft 66, via the dry outer clutch 46, via the outer input shaft 36, via the second fixed gearwheel 126, via the second idler gearwheel 138, via the second coupling device 146, and via the layshaft 124, to the pinion 140. The vehicle thus moves with the second gear. When the vehicle cruises at the second gear, the first coupling device 144 remains coupled to the first idler gearwheel 136, which causes both the first fixed gearwheel 128 and the inner input shaft 34 spinning.

When the vehicle stops, the dry double clutch 50 is again activated such that the dry outer clutch 48 disconnects the outer input shaft 36 from the crankshaft 66 and the dry inner clutch 46 connects the inner input shaft 34 to the crankshaft 66. Since the first coupling device 144 is engaged to the first idler gearwheel 136, the layshaft 124 immediately receives the driving torque from the inner input shaft 34, via the first fixed gearwheel 128, and via the first idler gearwheel 136, and via the first coupling device 144. This provides an engine brake effect via the first gear. The vehicle can be brought to a halt when a brake of the vehicle acts on wheels of the vehicle.

The double clutch transmission 120 is electronically controlled such that it can automatically return to the Neutral state when the vehicle stops. The dry double clutch 50 is deactivated in the Neutral state such that the dry inner clutch 46 disconnects from the inner input shaft 34 and the dry outer clutch 48 connects to the outer input shaft 36. As the second coupling device 146 disengages the layshaft 124 from the second idler gearwheel 138, the layshaft 124 does not receive driving torque from the crankshaft 66, via the dry outer clutch 48, via the second fixed gearwheel 126, via the second idler gearwheel 138 even though the engine is still running as the vehicle stops.

If parking is required, the lever is moved to Park position. Both the coupling devices 144, 146 move away from their respective idler gearwheels 136, 138 for decoupling. A park-lock gearwheel can be introduced on the layshaft 124 for providing the secure parking. With the park-lock gearwheel, a pawl can be shifted onto the park-lock gearwheel such that the pinion 140 is prevented from spinning, resulting in secure parking of the vehicle. The pinion 140 is coupled to a differential of the vehicle, which is not shown in FIG. 5.

More fixed and idler gearwheels can be introduced into the double clutch transmission 120 for providing other gear speeds. For example, a double clutch transmission with the dry double clutch 50 can provide seven gear speeds. In the double clutch transmission of seven gear speeds, gearwheels of odd gear speeds are driven by the dry inner clutch 46 via the inner input shaft 34, whilst gearwheels of even gear speeds are driven by the dry outer clutch 48 via the outer input shaft 36. This arrangement is similar to that of the double clutch transmission 120 in FIG. 5. The new double clutch transmission also provides pre-selection of gear speeds.

Since the dry inner clutch 46 is closed in the default position, the gearwheels of odd gear speeds can be preselected when any of the odd gear speeds is predicted for driving by an electronic engine control unit of the double clutch transmission. In contrast, the gearwheels of even gears can only be preselected when the dry double clutch 50 is in the activated position.

The double clutch transmission 120 provides the pre-selection to skip-shifts of gear speeds as well, either even to odd, or odd to even. For example, when performing gear speed skip-shift from seventh to fourth gear, the fourth gear can be preselected when the vehicle is driving at the seventh gear.

In contrast, the double clutch transmission 120 avoids pre-selection to skip-shifts of gear speeds even-to-even, or odd-to-odd. Sequential gearshifts provide smoother speed transition of the double clutch transmission 120. For example, the double clutch transmission 120 can reduces gear speeds from fifth, to fourth and then to third gear speed instead of jumping from fifth to third gear directly.

FIG. 7 illustrates working principles of the differentiation actuator 22 based on piezoelectric direct working system 161. The differentiation actuator 22 comprises the inner differentiator 164 on top and the outer differentiator 163 at bottom. Both the two differentiators 164, 166 are ring shaped and attached to the differentiator carrier 24 at their right sides. Both the inner differentiator 164 and the outer differentiator 163 are made of piezoelectric material of the same size. The two differentiators 163, 164 utilises a converse piezoelectric effect that they change their sizes upon receiving electric voltages. The differentiation actuator 22 utilises electric voltage to cause linear motions of the inner differentiator 164 and the outer differentiator 163. When applied with voltage, these two differentiators 164, 166 increase or decrease in size depending on polarity of the voltage.

FIG. 7 shows three states 168, 170, 172 of the differentiation actuator 22. In a first state 168 when there is no voltage applied to any of the two differentiators 164, 166, the two differentiators 164, 166 stays at their original size and they cause no linear displacement along the longitudinal axis 166. In the first state, the gaps 74, 76 at opposite sides of the inner friction plate 38 remains unchanged.

In a second state 170 when the voltage is applied to the inner differentiator 164 only, it swells in size towards left which slightly displaces the inner clutch bearing 78. The enlarged inner differentiator 164 causes the inner pressure plate 30 to be closer to the inner friction plate 38 and the centre plate 56, but still with slightly diminished gaps 74, 76 at opposite sides of the inner friction plate 38. The slight change of diminished gaps 74, 76 are known as micro change of opening.

In a third state 172 when the voltage is applied to the outer differentiator 163, the outer differentiator 163 enlarges towards left. The expanded outer differentiator 163 bulges against the outer clutch bearing 80 such that the outer pressure plate 32 holds the outer friction plate 40 tighter against the centre plate 56. The tighter closure of the dry outer clutch 48 is also known as micro change of closure.

FIG. 8 illustrates a torque-travel diagram of the dry outer clutch 48 with the micro change of closure. The torque-travel diagram is shown in a two dimensional Cartesian coordinate. A vertical axis 174 of the diagram indicates normalised clutch torque of the dry outer clutch 48, which has an open or a close state. On the other hand, a horizontal axis 176 of the diagram represents stroke distance of the dry outer clutch 48, from zero to full. The diagram further has a solid line 178 that indicates a travel course of the dry outer clutch 48 in the absence of the outer differentiator 163. A dash line 180 in the diagram is parallel to the solid line 178, which represents a travelling course of dry outer clutch 48 with the micro change of closure. The dash line 180 represents linear differentiation of the outer differentiator 163, which provides a constant increment to opening of the dry outer clutch 48.

According to FIG. 8, the dry outer clutch 48 provides higher torque when the outer differentiator 163 receives the voltage. The voltage is applied proportional to the amount of wear of the dry outer clutch 48 in use. In other words, as material of the dry outer clutch 48 is worn off during usage, the outer differentiator 163 causes the outer friction plate 40 to be closer to the outer pressure plate 32 and to the centre plate 56 for compensation of the material loss. The dry outer clutch 48 can work reliably throughout its life span even the wear occurs.

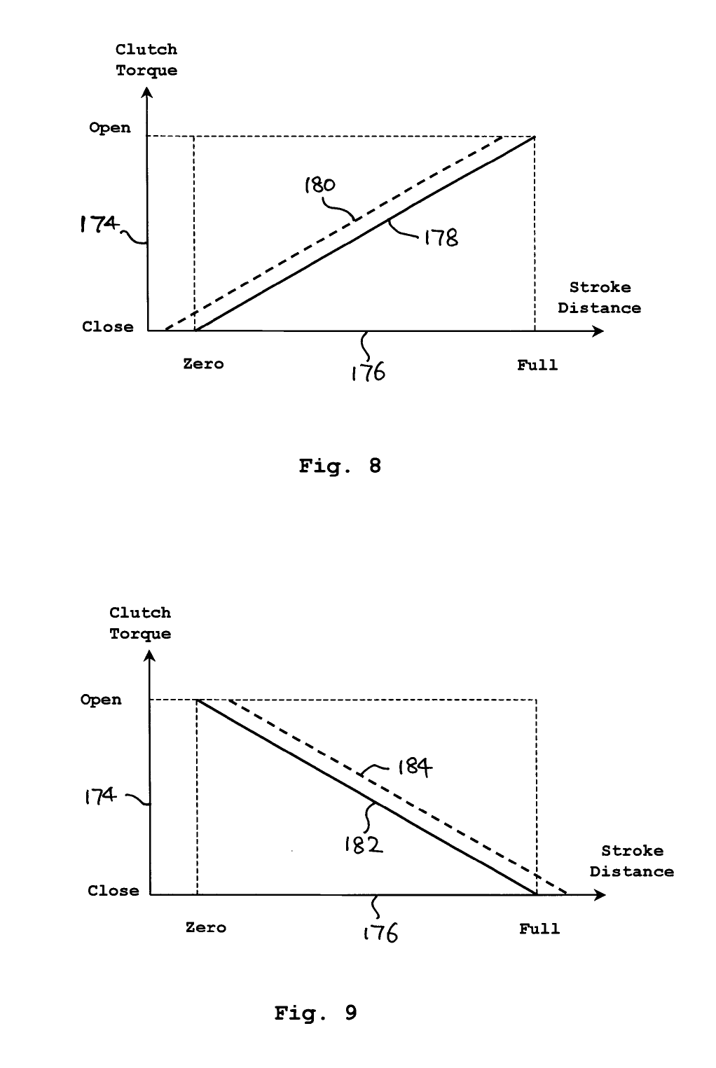

FIG. 9 illustrates a torque-travel diagram of the dry inner clutch 46 with the micro change of opening. The torque-travel diagram is also shown in a two dimensional Cartesian coordinate. The diagram further has a solid line 182 that indicates a travel course of the dry inner clutch 46 in the absence of activation of the inner differentiator 164. A dash line 184 in the diagram is parallel to the solid line 182, which represents a travelling course of dry inner clutch 46 with the micro change of opening.

According to FIG. 9, the dry inner clutch 164 provides higher torque when the inner differentiator 164 receives the voltage. The voltage is applied proportional to the amount of wear of the dry inner clutch 48 in use. In other words, as material of the dry inner clutch 48 is worn off during usage, the inner differentiator 164 causes the inner friction plate 38 to be closer to the inner pressure plate 30 and the centre plate 56 for compensating the material loss. The dry inner clutch 46 can work reliably throughout its life span even when the wear occurs.

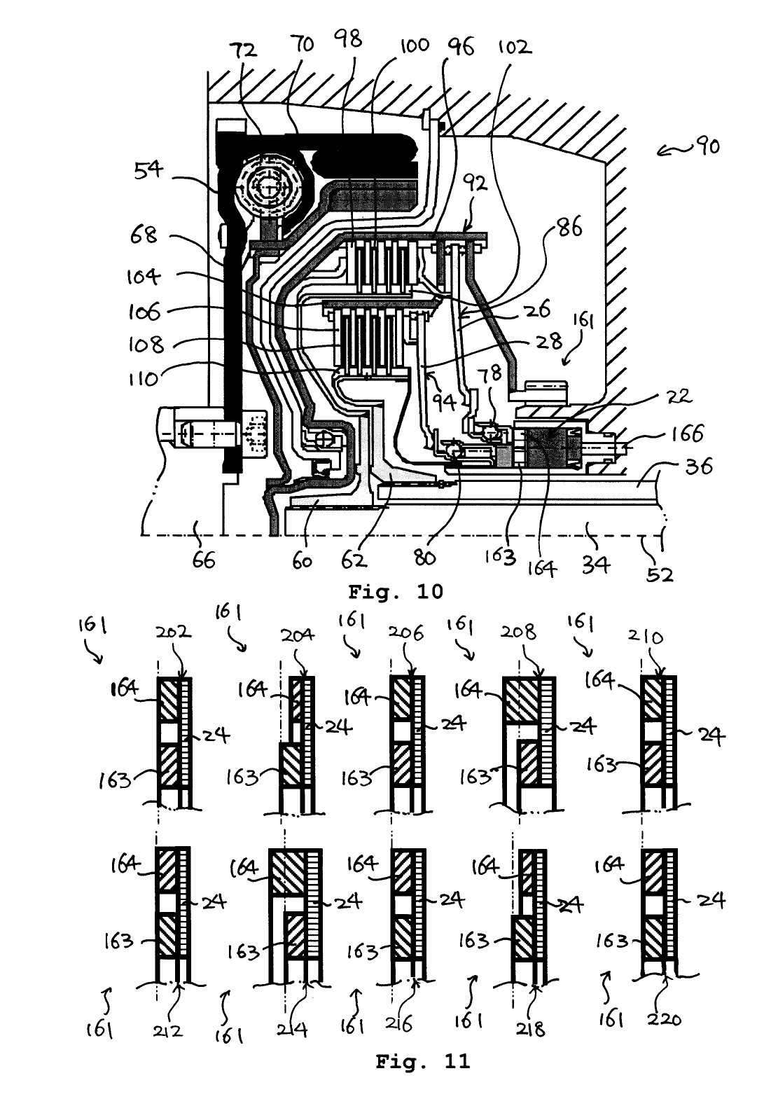

FIG. 10 describes detailed description of a wet double clutch 90 of the present application. FIG. 10 comprises parts that have same reference numbers. Relevant description of these parts is incorporated where appropriate.

FIG. 10 illustrates the wet double clutch 90 according to the schematic diagram of FIG. 1. The wet double clutch 90 comprises a wet inner clutch 92 and a wet outer clutch 94 that are detachable to a dual mass flywheel 54. The dual mass flywheel 54 is fixed onto a crankshaft 66 via a secondary flywheel 68 such that the crankshaft 66 can drive the dual mass flywheel 54 around their common longitudinal axis 52. The wet inner clutch 92 is detachably coupled to an inner input shaft 34, whilst the wet outer clutch 94 is also detachably coupled to an outer input shaft 36.

The wet inner clutch 92 comprises an inner pressure plate carrier 96, an array of inner pressure plates 98, a stack of inner friction plates 100 and an inner friction plate carrier 102. The inner pressure plates 98 are parallel to each other and they are rooted onto the inner pressure plate carrier 96. An inner clutch lever 28 supports the inner pressure plate carrier 96 at its right end such that the inner pressure plates 98 can rotate around the longitudinal axis 52. Each of the inner friction plates 100 is inserted between neighbouring inner pressure plates 98. Gaps are present between the inner pressure plate 98 and the inner friction plate 100 that are adjacent to each other. Inner friction plate carrier 102 holds the inner friction plates 100 such that the inner friction plates 100 can revolve around the longitudinal axis 52 without interfering with the inner pressure plates 98. An inner splined hub 60 on the inner input shaft 34 supports the inner friction plate carrier 102.

On the other hand, the wet outer clutch 94 comprises an outer pressure plate carrier 104, an array of outer pressure plates 106, a stack of outer friction plates 108 and an outer friction plate carrier 110. The outer pressure plates 106 are parallel to each other and they are rooted at the outer pressure plate carrier 104. An outer clutch lever 26 supports the outer pressure plate carrier 104 at its right end such that the outer pressure plates 106 can rotate around the longitudinal axis 52. Each of the outer friction plates 110 is inserted between neighbouring outer pressure plates 106. An outer splined hub 62 on the outer input shaft 36 supports the outer friction plate carrier 108. The adjacent outer pressure plates 106 and the outer friction plates 108 are clenched to each other by default. In the default state, the wet double clutch 90 is deactivated that the outer friction plate carrier 108 holds the outer friction plates 110 onto the outer pressure plates 106, thus joining the outer input shaft 36 to the crankshaft 66.

The outer clutch lever 26 and the inner clutch lever 28 are supported by an inner clutch bearing 78 and an outer clutch bearing 80 respectively at their bottom ends. The inner clutch bearing 78 and the outer clutch bearing 80 are further supported by an outer differentiator 163 and an inner differentiator 164 respectively. Similar to that of the dry dual clutch 50, the two differentiators 163, 164 are mounted onto a differentiator carrier 24 of the differentiation actuator 22 such that the differentiation actuator 22 can push the two clutch levers 26, 28 towards left for activation.

A restoring mechanism 86 of the wet double clutch 90 comprises the differentiation actuator 22, the inner branch 82, the outer branch 84, the inner clutch bearing 78, the outer clutch bearing 80, the outer clutch lever 26, the inner clutch lever 28, the inner pressure plate carrier 96, the inner pressure plates 98, the inner friction plates 100, the inner friction plate carrier 102, the outer pressure plate carrier 104, the outer pressure plates 106, the outer friction plates 108, the outer friction plate carrier 110, the inner splined hub 60 and the outer splined hub 62.

FIG. 10 also describes a default position of the wet double clutch 90. In the default position, the inner branch 82 and the outer branch 84 receive no force from the differentiation actuator 22 so that the bottom ends of the outer clutch lever 26 and the inner clutch lever 28 are at their right-most locations. Both the wet inner clutch 92 and the wet outer clutch 94 are held at the default position by resilience of the outer clutch lever 26 and the inner clutch lever 28.

The wet inner clutch 92 engages the inner input shaft 34 to the crankshaft 66 and the wet outer clutch 94 disengages the outer input shaft 36 from the crankshaft 66 in the default position. In detail, the inner pressure plates 98 are pushed onto the inner friction plates 100 for engaging the inner input shaft 34. In contrast, gaps exist between the outer pressure plates 106 and their neighbouring outer friction plates 108. Consequently, the inner splined hub 60 locks the inner input shaft 34 such that the inner input shaft 34 receives driving torque from the crankshaft 66.

On the other hand, in an activated position, the differentiation actuator 22 advances towards left which causes both the inner clutch bearing 78 and the outer clutch bearing 80 to shift towards the left as well. The differentiation actuator 22 causes the outer clutch lever 26 and the inner clutch lever 28 to tilt which result in engaging the wet outer clutch 94 and releasing the wet inner clutch 92. When the wet outer clutch 94 is engaged, the outer pressure plates 106 and the outer friction plates 108 come so that the driving torque of the crankshaft 66 is transmitted to the outer splined hub 62 and further to the outer input shaft 36.

The wet double clutch 90 locks either the inner input shaft 34 or the outer input shaft 36 to the crankshaft 66 for driving torque transmission by releasing or advancing the differentiation actuator 22.

FIGS. 11-13 facilitate detailed description of a further embodiment of a dry double clutch 50. FIGS. 11-13 comprise parts that have reference numbers same as other Figures. Relevant description of these parts is incorporated where appropriate.

FIG. 11 illustrates various operating status of the dry double clutch 50 with differentiators 163, 164. The dry double clutch 50 includes the outer differentiator 163 and the inner differentiator 164.

The two differentiators 163, 164 are piezoelectric material based such that they increase their sizes when receiving positive electric voltage. They also decrease their sizes when applied with negative electric voltage. Polarity of the electric voltage is determined by size variations of the two differentiators 163, 164.

In FIG. 11, there are five different states 202, 204, 206, 208, 210 for indicating size variations of the differentiators 163, 164. In a first state 202, both the inner and outer differentiators 163, 164 have no electric voltage applied. In a second state 204, the outer differentiator 163 receives negative electric voltage charge that it decreases in length. In a third state 163, 164, both the inner differentiator 164 and the outer differentiator 163 receive no electric voltage. In a subsequent fourth state 208, the outer differentiator 163 gets a positive voltage that it increases in size. In a fifth state, the two differentiators 163, 164 are again in the absence of voltage application.

FIG. 11 also shows five states 212, 214, 216, 218, 220 of the inner differentiator 164. In a first state 212, the outer differentiator 163 and the inner differentiator 164 have no voltage applied to them such that they stay at their original sizes. In the second state 214, the inner differentiator 164 obtains positive voltage and it increases size accordingly. When the positive voltage is removed, as in a third state 216, the inner differentiator 164 backs to its original size, which is similar to that of the outer differentiator 163. In a fourth state 218, the inner differentiator 164 is applied with a negative voltage such that it decreases its size. In a last fifth state 220, both the inner and outer differentiator 163, 164 are free from voltage application and they return to their original sizes.

These states 202-220 of the two differentiators 163, 164 provide examples on how the differentiation actuators 163, 164 work. Size variations of the inner differentiator 164 and the outer differentiator 163 provide means for making micro changes in opening and closure of the dry double clutch 50.

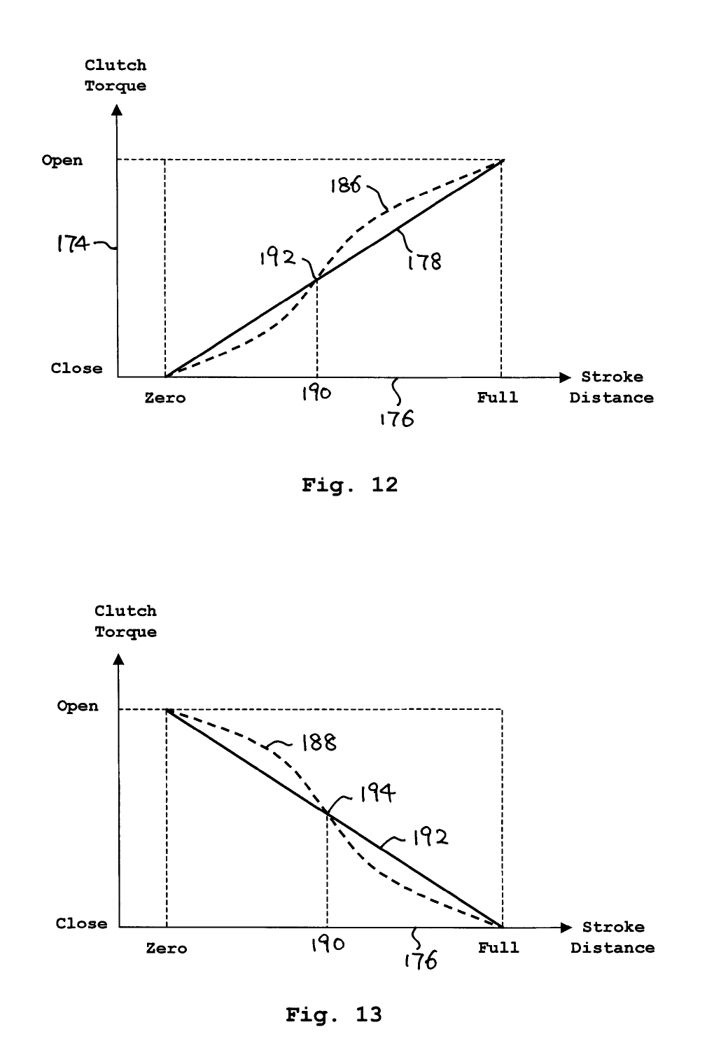

FIG. 12 illustrates a torque-stroke diagram of the dry outer clutch 50 with another micro change of closure. Similar to FIG. 8, the torque-stroke diagram has a two dimensional Cartesian coordinate with a vertical axis 174 and a horizontal axis 176. The vertical axis 174 represents normalised clutch torque of the dry outer clutch 48 from open to close state. The horizontal axis 176 indicates stroke distance of the dry outer clutch 48, including a full stroke distance and a zero stroke distance. The diagram further has a diagonal solid line 178 that designates a travel course of the dry outer clutch 48 in the absence of the functioning of the outer differentiator 163. A dash line 186 in the diagram is intertwined with the solid line 178, and it points out a travelling course of dry outer clutch 48 with the micro change of closure. The dash line 186 represents non-linear differentiation of the inner differentiator 164. The outer differentiator 163 changes its size over the entire stroke distance when having the non-linear differentiation.

There is a middle point 190 on the horizontal axis 176 and it indicates a position at a half of a complete stroke distance of the dry outer clutch 48. Correspondingly, a turning point 192 is marked on the solid line 178, which indicates a midway of the complete stroke distance. Before the turning point 192, the inner differentiator 163 receives a negative voltage. Beyond the turning point 192, a positive voltage is applied to the inner differentiator 163.

In an opening process of FIG. 12, the dry outer clutch 48 stays at its default position with zero stroke distance initially. The two differentiators 163, 164 are not charged that they keep their original size, as in the first state 202. At the first state 202, the dry outer clutch 48 is closed. Subsequently, the dry outer clutch 48 opens as the outer pressure plate 32 gradually releases. In the mean time, the outer differentiator 163 receives a negative voltage at the second state 204. The negative voltage increases its magnitude first and later decreases, which slightly delay opening of the dry outer clutch 48.

When the dry outer clutch 48 reaches a middle opening position 192 of the stroke distance, the negative voltage decreases to zero such that the outer differentiator 163 backs to its original size, being at the third state 206.

As the dry outer clutch 48 further opens beyond the midway 192, the outer differentiator 163 receives a positive electric voltage such that the outer differentiator 163 increases its size as shown in the fourth state 208. The augmentation of size causes the dry outer clutch 48 opens narrower. The positive voltage initially increases, but later decrease. As the dry outer clutch 48 approaches its full stroke distance, the outer differentiator 163 is released from the positive voltage, arriving at the fifth state 210.

An entire opening process of the dry outer clutch 48 is shown by the dash line 186, which represents differentiation actuator 22 under the influence of electric voltage. In contrast, the solid line 178 indicates the path of the differentiation actuator 22 without voltage application.

FIG. 13 illustrates a torque-stroke diagram of a dry inner clutch 46 with another micro change of opening. Similar to FIG. 9, the torque-stroke diagram has a two dimensional Cartesian coordinate that has a horizontal axis 176 and a vertical axis 174. The vertical axis 174 stands for normalised clutch torque of the dry inner clutch 46 from open to close. The horizontal axis 176 indicates stroke distance of the dry inner clutch 46, including a full stroke distance and a zero stroke distance. The diagram further has a diagonal solid line 182 that indicates a travel course of the dry inner clutch 46 in the absence of the inner differentiator 164. A dash line 188 in the diagram is intertwined with the solid line 178, and the dash line 188 points out a travelling course of dry inner clutch 46 with the micro change of closure. FIG. 13 also indicates non-linear differentiation of the inner differentiator 164. Sizes of the inner differentiator 164 vary depending on its received voltage.

There is a middle point 190 on the horizontal axis 176 and the middle point 190 indicates a position at a half of a complete stroke distance of the dry inner clutch 46. Correspondingly, a turning point 194 is marked on the solid line 182, which indicates a midway of the complete stroke distance.

In a closing process of FIG. 13, the dry inner clutch 46 stays open at its default position with zero stroke distance initially. The two differentiators 163, 164 are not charged that they keep their original size, as in the first state 212. At the first state 212, the dry inner clutch 46 is fully open. Subsequently, the dry inner clutch 46 closes as the inner pressure plate 30 gradually moves closer to the centre plate 56. In the mean time, the inner differentiator 164 receives a positive voltage at the second state 214 and the inner differentiator 164 increases its size, which causes slight deceleration in the closing. The positive voltage increases from zero to a high value and then reduces.

When the dry inner clutch 46 reaches a middle opening position 194 of the stroke distance, the positive voltage decreases to zero such that the inner differentiator 164 backs to its original size, being at the third state 216.

As the dry inner clutch 46 further closes beyond the midway 194, the inner differentiator 164 receives a negative electric voltage such that the inner differentiator 164 decreases it size as shown in the fourth state 218. The augmentation of size causes the dry inner clutch 46 to close narrower. The negative voltage initially increases, but later subsides in magnitude. As the dry inner clutch 48 approaches its full stroke distance, the inner differentiator 164 is relieved from the negative voltage, arriving at the fifth state 220.

An entire closing process of the dry inner clutch 46 is shown by the dash line 188, which represents differentiation actuator 22 under the influence of electric voltage. In contrast, the solid line 182 indicates the path of the differentiation actuator 22 without voltage application.

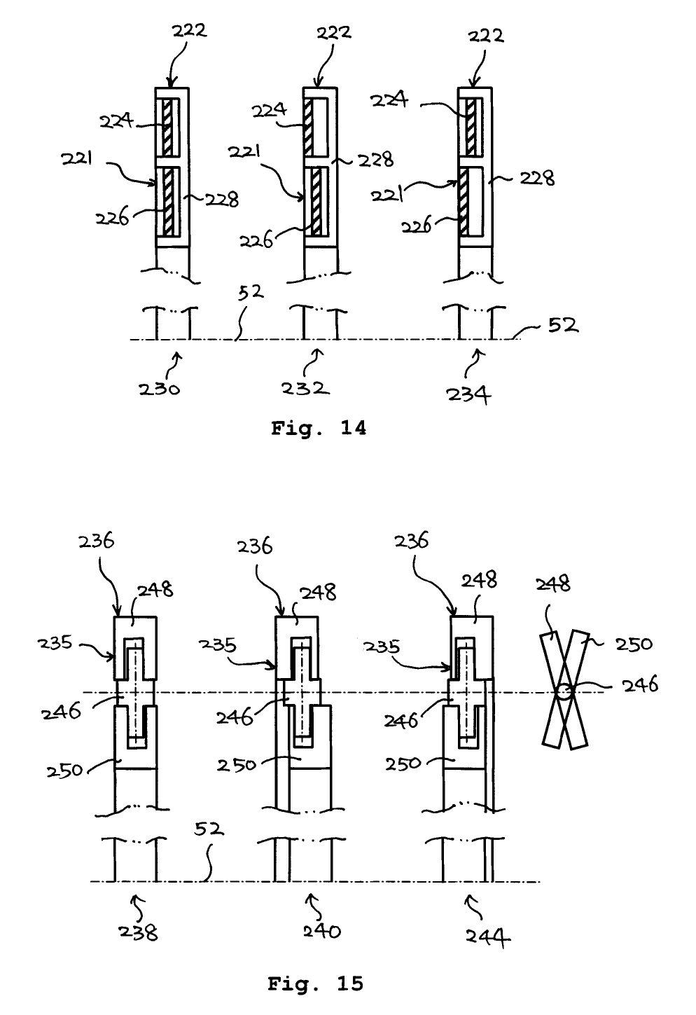

FIG. 14 illustrates working principles of a differentiation actuator 222 based on hydraulic direct working system 221. The differentiation actuator 222 comprises an inner differentiation actuator 224 and an outer differentiation actuator 226. An electro hydraulic differentiator carrier 228 holds both the inner differentiation actuator 224 and the outer differentiation actuator 226. The inner differentiation actuator 224, the outer differentiation actuator 226 and the electro hydraulic differentiator carrier 228 are annular shaped and only their cut-off portions are shown in FIG. 14. The electro hydraulic differentiator carrier 228 is a linear hydraulic motor with two cylinders. These two cylinders hold two pistons in the form of the inner differentiation actuator 224 and the outer differentiation actuator 226. Each of the two differentiation actuators 224, 226 can move inside the cylinders from right to left, and vice versa.

FIG. 14 presents three states of the differentiation actuator 222 for explaining micro change of opening and closure. In a first state 230, both the inner differentiation actuator 224 and the outer differentiation actuator 226 are deactivated such that they stay at their neutral position. The two differentiation actuators 224, 226 are held by the electro hydraulic differentiator carrier 228 and follow the movement of the dry inner clutch 46 and the dry outer clutch 48. When in use, the travel course of the dry outer clutch 48 with the outer differentiation actuator 226 is similar to the solid line 178 in FIG. 8. The travel course of the dry inner clutch 46 with the inner differentiation actuator 224 is similar to the solid line 182 in FIG. 9 in the usage.

In a second state 232, the inner differentiation actuator 224 is pushed forward with the micro change whilst the outer differentiation actuator 226 remains deactivated. The electro hydraulic differentiator carrier 228 holds the two differentiation actuators 224, 226 to the dry inner clutch 46 and the dry outer clutch 48 respectively. When in the second state 232, a travel course of the dry inner clutch 46 with the inner differentiation actuator 224 is similar to the dash line 184 in FIG. 9.

In a third state 234, the outer differentiation actuator 226 is pushed forward with the micro change and the inner differentiation actuator 224 is deactivated. The electro hydraulic differentiator carrier 228 attaches the two differentiation actuators 224, 226 to the dry inner clutch 46 and the dry outer clutch 48 respectively. When in the third state 234, a travel course of the dry outer clutch 46 with the outer differentiation actuator 226 is similar to the dash line 180 in FIG. 8.

FIG. 15 illustrates working principles of a differentiation actuator 236 based on a mechanically actuated indirect system 235. The differentiation actuator 236 comprises an inner differentiation actuator 250 and an outer differentiation actuator 248. A guiding roller 246 has opposite ends that are inserted into the inner differentiation actuator 250 and the outer differentiation actuator 248 for moving the two differentiation actuators 248, 250 forward and backward in a direction following the longitudinal axis 52. Since the inner differentiator 250 and the outer differentiator 248 are attached to the dry inner clutch 46 and the dry outer clutch 48 respectively, rotation of the guiding roller 246 causes micro changes to stroke distances of the two clutches when in use.

FIG. 15 provides three states of the differentiation actuator 236 for explaining micro change of opening and closure. In a first state 238, the guiding roller 246 stays at its default neutral position, which does not cause any micro change to any of the inner differentiation actuator 248 and the outer differentiation actuator 250. When in use, a travel course of the dry outer clutch 48 with an outer differentiation actuator 250 is similar to the solid line 178 in FIG. 8. A travel course of the dry inner clutch 46 with the inner differentiation actuator 248 is similar to the solid line 182 in FIG. 9 in usage.

In a second state 240, the guiding roller 246 rotates which causes the inner differentiation actuator 248 to move ahead with the micro change whilst the outer differentiation actuator 250 remains deactivated. When in the second state 236, a travel course of the dry inner clutch 46 with the inner differentiation actuator 248 is similar to the dash line 184 in FIG. 9.

In a third state 242, the outer differentiation actuator 250 is pushed forward with the micro change and the inner differentiation actuator 248 is deactivated. The electro hydraulic differentiator carrier 228 attaches the two differentiation actuators 248, 250 to the dry inner clutch 46 and the dry outer clutch 48 respectively. When in the third state 242, a travel course of the dry outer clutch 46 with the outer differentiation actuator 250 is similar to the dash line 180 in FIG. 8.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A double clutch comprising:
an inner clutch connecting an inner input shaft to a crankshaft of an engine;
an outer clutch connecting an outer input shaft to the crankshaft); and
at least one differentiator coupled to at least one levers of the inner clutch and the outer clutch and configured to provide adjustments in stroke distance to at least one of the inner clutch or the outer clutch for clutching.

2. The double clutch of claim 1, wherein the at least one differentiator comprises an inner differentiator and an outer differentiator, the inner differentiator coupled to the inner clutch for providing a first adjustment in stroke distance of the inner clutch, and the outer differentiator is coupled to the outer clutch for providing a second adjustment in stroke distance of the outer clutch.

3. The double clutch of claim 2, further comprising a differentiation actuator coupled to the inner differentiator and the outer differentiator, the differentiation actuator being operable between a deactivated position and an activated position to engage the crankshaft to one of the two input shafts and disengage the crankshaft from the other one of the two input shafts in parallel.

4. The double clutch of claim 3, wherein the crankshaft is disengaged from the inner input shaft by the inner clutch and the crankshaft is engaged to the outer input shaft by the outer clutch in the deactivated position.

5. The double clutch of claim 4, further comprising: a dry double clutch such that the inner differentiator is contiguous to the inner clutch bearing of the dry double clutch and the outer differentiator is contiguous to the outer clutch bearing of the dry double clutch.

6. The double clutch of claim 1, comprising:
a wet double clutch comprising a wet inner clutch and a wet outer clutch that are radially disposed around a longitudinal axis of the wet double clutch.

7. The double clutch of claim 3, wherein the differentiation actuator provides linear differentiation to the inner differentiator and the outer differentiator.

8. The double clutch of claim 3, wherein the differentiation actuator provides non-linear differentiation to the inner differentiator and the outer differentiator.

9. The double clutch of claim 1, wherein the inner actuator and the outer actuator comprises a piezoelectric direct working system.

10. The double clutch of claim 1, wherein the two differentiators comprises a hydraulic direct working system.

11. The double clutch of claim 1, wherein the two differentiators comprises a mechanically actuated indirect system.

12. A double clutch transmission comprising:
an inner input shaft and an outer input shaft, at least a portion of the inner input shaft surrounded by the outer input shaft;
a layshaft spaced apart from the inner input shaft and the outer input shaft and arranged in parallel to the inner input shaft;
a pinion mounted on the layshaft;
gearwheels of a launch gear mounted on one of the inner input shaft and the outer input shaft and the layshaft, the gearwheels comprising a driving gearwheel on the one of the inner input shaft and the outer input shaft meshing with a driven gearwheel on the layshaft;
a coupling device of the launch gear on the layshaft, and
a double clutch, comprising:
an inner clutch connecting the inner input shaft to a crankshaft of an engine;
an outer clutch connecting the outer input shaft to the crankshaft); and
at least one differentiator coupled to at least one levers of the inner clutch and the outer clutch and configured to provide adjustments in stroke distance to at least one of the inner clutch or the outer clutch for clutching.

13. The double clutch transmission of claim 12, further comprising:
the gearwheels comprising a second driven gearwheel connected to the double clutch in a deactivated position.

14. The double clutch transmission of claim 13, wherein the at least one differentiator comprises an inner differentiator and an outer differentiator, the inner differentiator coupled to the inner clutch for providing a first adjustment in stroke distance of the inner clutch, and the outer differentiator is coupled to the outer clutch for providing a second adjustment in stroke distance of the outer clutch.

15. The double clutch transmission of claim 14, further comprising a differentiation actuator coupled to the inner differentiator and the outer differentiator, the differentiation actuator being operable between the deactivated position and an activated position to engage the crankshaft to one of the two input shafts and disengage the crankshaft from the other one of the two input shafts in parallel.

16. The double clutch transmission of claim 15, wherein the crankshaft is disengaged from the inner input shaft by the inner clutch and the crankshaft is engaged to the outer input shaft by the outer clutch in the deactivated position.

17. The double clutch transmission of claim 16, further comprising: a dry double clutch such that the inner differentiator is contiguous to the inner clutch bearing of the dry double clutch and the outer differentiator is contiguous to the outer clutch bearing of the dry double clutch.

18. The double clutch transmission of claim 12, comprising:
a wet double clutch comprising a wet inner clutch and a wet outer clutch that are radially disposed around a longitudinal axis of the wet double clutch.

19. The double clutch transmission of claim 15, wherein the differentiation actuator provides linear differentiation to the inner differentiator and the outer differentiator.

20. A method for using a double clutch comprising:
providing the double clutch that has an inner clutch and an outer clutch; and
activating the double clutch by engaging the inner clutch to an input shaft and disengaging the outer clutch other from the outer clutch simultaneously.
